(19) United States
(12) Patent Application Publication
(10) Pub. No.: US 2012/0065363 A1
(43) Pub. Date: Mar. 15, 2012

(54) Catalytic conversion of sugars to polyethers

(75) Inventor: Melvin Keith Carter, Lincoln, CA (US)

(73) Assignee: Carter Technologies, Lincoln, CA (US)

(21) Appl. No.: 12/807,690

(22) Filed: Sep. 13, 2010

(51) Int. Cl. C08G 65/22

(52) U.S. Cl. 528/411; 528/417; 528/412; 528/410

(57) ABSTRACT

Sugars comprising the monosaccharides glucose and fructose, and the disaccharides sucrose and lactose are catalytically converted to polyethers in a sulfate fortified acid medium in the presence of transition metal compounds possessing a degree of symmetry. The conversion efficiency of this catalytic chemical process is improved by saturating the acidic reaction mixture with inorganic sulfate salts to reduce competitive reactions. Polyethers formed during the reaction are removed by filtration facilitating a continuous process.

### BACKGROUND

1. Field of Invention

This invention relates to catalytic chemical conversion of sugars comprising monosaccharides and disaccharides to polyethers at substantial yields in a single process step. Specifically, this application discloses rapid, efficient catalytic conversion of sugar materials including sucrose, lactose, glucose, fructose and galactose in an acid medium containing inorganic sulfates comprising alkali metal and alkaline earth sulfates to polyethers employing catalysts based on transition metal complexes possessing a degree of symmetry as described herein.

2. Description of Prior Art

The chemical process industry has grown to maturity based on petroleum feed stocks, a non-renewable resource that may become unavailable in the next 100 years. This planet Earth fosters continual growth of abundant carbohydrate based plants including cane and beet sugars, fruits, vegetables, starches, grain food sources, grasses, shrubs, trees and related natural materials. Trees, corn cobs, support plant stalks, reeds and grasses are subject to steam, dilute acid and catalytic digestion processes converting cellulosic materials to sugar substances. These processes are many times faster and more efficient than biochemical or fermentation processes. A major industry is growing where in billions of gallons of ethanol are produced from food sugars as well as sugar substances made from wood and other cellulose materials.

More than thirty percent of products produced from refined petroleum are polymers. These polymers are produced by converting petroleum to reactive liquids and gases including ethylene, acetylene, propylene, butane, butadiene, acrylic acid, acrolein and others. A chemical industry based on renewable cellulose resources also needs to produce polymers. The polyether production process disclosed herein is fundamental for efficient catalytic conversion of essentially all sugar materials to polyethers for use in a modern chemical process industry where raw materials are grown rather than refined from petroleum.

Apparently there is a paucity of prior art teaching production of polyethers from sugars including fructose, glucose, galactose, sucrose, lactose and others sugar substances. Instead, prior art teaches how to isolate natural polymers from plant materials. For example, U.S. Pat. No. 5,895,686, issued Apr. 20, 1999, teaches a process of producing glycogen, a plant glucose polymer, from finely ground rice powder. Plant glycogen is a polysaccharide derived from rice and contains a high molecular weight group whose weight average molecular weight is 5.00 to 7.60 million and a low molecular weight group whose weight average molecular weight is 0.30 to 1.10 million. Glycogen is a glucose polymer, being easily dissolved in cold water and hot water, and being rendered viscous at the time of water addition of 25 to 200%. The process for producing plant glycogen, includes immersing finely ground rice in water or a water-containing solvent, subjecting it to solid-liquid separation to give an extract, heating it to remove thermally precipitated solids and proteins, adding the resulting liquid layer to an organic solvent, and recovering the resulting white precipitates, followed by purification, if necessary. U.S. Pat. No. 5,547,863, issued Aug. 20, 1996, discloses a process for formation of Fructan (Levan) a fructose polymer of β-2,6-fructofuranoside produced by strains of Bacillus polymyxa. Soil isolates, identified as strains of Bacillus polymyxa, NRRL B-18475 and NRRL B-18476, produce large quantities of a pure and uniform extracellular polysaccharide fructan (levan), in a sucrose medium. The levan consists entirely of fructose and the residues linked by β-2-6 fructofuranoside linkage. U.S. Pat. No. 5,089,401, issued Feb. 18, 1992, offers an enzymatic method for preparation of a fructose oligosaccharide in which a β-fructofuranosidase was made from Arthrobacter. An enzymatic method for the preparation of a fructose-containing oligosaccharide, in which a β-fructofuranosidase obtained by culturing Arthrobacter sp. K-1 (FERM BP-3192) as an enzyme is reacted on sucrose, raffinose or stachyose as the donor in the presence of an aldose or ketose as the receptor. These natural biological growth processes are slow and do not teach direct catalytic conversion of essentially any sugar to polyethers.

The present application discloses use of low valent mono-metal, di-metal, tri-metal and/or poly-metal backbone or molecular string type transition metal catalysts, as described in this application, for direct production of polyethers from sugar materials in a few minutes rather than days or weeks as required by biological processes. In addition, catalytic conversion processes are not limited to a single strain or catalyst but are effective using any of a range of catalysts.

### SUMMARY OF THE INVENTION

This invention describes a chemical process using selected members of transition metal catalysts possessing a high degree of symmetry in their lower valence states for catalytic conversion of sugar materials to branched ether polymers. This process is rapid and direct in that sugars are placed into solution with the catalytic acid medium at reaction conditions wherein polymers form and are isolated by filtration. Biological processes are not required.

It is an object of this invention, therefore, to provide a catalytic process facilitating conversion of sugar materials to polyether compounds in a sulfate fortified acid digestion medium. It is another object of this invention to catalytically convert sugar materials to branched ether polymers at normal ambient pressure. It is still another object of this invention to catalytically convert sugar materials to branched ether polymers at elevated temperature. Other objects of this invention will be apparent from the detailed description thereof which follows, and from the claims.

### DETAILED DESCRIPTION OF THE INVENTION

A process for catalytic chemical conversion of sugar materials comprising monosaccharides, including glucose and fructose, and disaccharides, including sucrose and lactose, to polyether compounds is taught. The process for conversion of sugar materials to polyethers uses no fermentation and is conducted in a sulfate fortified acid medium using transition metal compounds, such as [manganese]₂, [vanadium]₂, [copper]₂ or [cobalt]₂ compounds, for which the transition metals and directly attached atoms possess C₄ᵥ, D₄ₕ or D_{2d} point group symmetry. These catalysts have been designed based on a formal theory of catalysis, and the catalysts have been produced, and tested to prove their activity. The theory of catalysis rests upon a requirement that a catalyst possess a single metal atom or a molecular string such that transitions from one molecular electronic configuration to another be barrier free so reactants may proceed freely to products as driven by thermodynamic considerations. Catalysts effective for chemical conversion of sugars to polyethers can be made from mono-metal, di-metal, tri-metal and/or poly-metal backbone or molecular string type compounds of the transition metals comprising titanium, vanadium, chromium, manganese, iron, cobalt, nickel, copper, zirconium, niobium, molybdenum, ruthenium, rhodium, palladium, silver, hafnium, tantalum, tungsten, rhenium, osmium, iridium, platinum, gold or combinations thereof. These catalysts are typically made in the absence of oxygen so as to produce compounds wherein the oxidation state of the transition metal is low, typically monovalent, divalent or trivalent. Anions employed for these catalysts comprise fluoride, chloride, bromide, iodide, cyanide, isocyanate, thiocyanate, sulfate, phosphate, oxide, hydroxide, oxalate, acetate, organic chelating agents and/or more complex groups. Mixed transition metal compounds have also been found to be effective catalysts for some chemical conversions.

These catalysts act on glucose, fructose, sucrose, lactose and essentially any sugar type carbohydrate compound to generate free radicals in times believed to be the order of or less than that of a normal molecular vibration. This may be viewed as generation of free radical reactants in equilibrium such that the reaction indicated by the equation C₆H₁₂O₆→polyether+water may proceed. Fortifying the acid medium with inorganic sulfates essentially saturates the solvent and reduces the tendency to form known by products.

### Catalyst Selection Considerations

A Concepts of Catalysis effort formed a basis for selecting molecular catalysts for specified chemical reactions through computational methods by means of the following six process steps. An acceptable chemical conversion mechanism, involving a single or pair of transition metal atoms, was established for the reactants (step 1). A specific transition metal, such as cobalt, was selected as a possible catalytic site as found in an M or M-M string (step 2), bonded with reactant molecules in essentially a C₄ᵥ, D₄ₕ or D_{2d} point group symmetry configuration, and having a computed bonding energy to the associated reactants of 0>E>−60 kcal/mol (step 3). The first valence state for which the energy values were two-fold degenerate was 2+ in most cases although 1+ is possible (step 4). Sulfate, chloride and other anions may be chosen provided they are chemically compatible with the metal in formation of the catalyst (step 5). An inspection of the designed catalyst should also be conducted to establish compliance with the rule of 18 (or 32) to stabilize the catalyst; thus, compatible ligands may be added to complete the coordination shell (step 6). This same process may be applied for selection of a catalyst using any of the first, second or third row transition metals, however, only those with acceptable negative bonding energies can produce effective catalysts. The approximate relative bonding energy values may be computed using a semi-empirical algorithm or other means. Such a computational method indicated that most of the first row transition metal complexes may be anticipated to produce usable catalysts once the outer coordination shell had been completed with ligands. In general, transition metal carbohydrate complexes are indicated to produce useable catalysts once bonding ligands have been added.

Catalyst structures commonly including a pair of bonded transition metal atoms require chelating ligands and/or bonding orbital structures that may be different for each metal. The following compounds comprise a limited selection of examples. For the first row transition metals vanadium catalysts comprise vanadium(II) oxide, (VOSO₄)₂, and (VF₂)₂ having V-V bonds and ethylenediamine (EDA) links the metals in (VCl₂)₂(EDA)₂, ethanol or other reactants may displace a CO and/or THF in the compound [V(THF)₄Cl₂][V(CO)₆]₂ while V₂(SO₄)₃ may also be useful. Chromium catalysts comprise Cr(O₂CCH₃)₂(HO₂CCH₃)₂, Cr₂[CH₃(C₅H₃N)O]₄, (CrCl₂)₂.2EDA, (CrBr₂)₂(EDA)₂, [Cr(OH)₂]₂(EDA)₂ and Cr₂(O₂CCH₃)₄(H₂O)₂ where a reactant may displace waters of hydration. Manganese catalysts comprise [Mn(diethyldithiocarbamate)]ₙ, (MnCl₂)₂(EDA)₂, K₂[Mn₂Cl₆(H₂O)₄] and Mn₂(C₅H₈O₂)₄(H₂O)₂. Iron catalysts comprise (FeCl₂)₂(EDA)₂, (FeBr₂)₂(EDA)₂ and Fe₂(SO₄)₂. Cobalt catalysts comprise Co₂(C₆H_{S}O₂)₂(C₆H₆O₂)₂, Co₂(C₅H₈O₂)₄(H₂O)₂, Co(C₆H_{S}O₂)₂(C₆H₆O₂)₂, Co₂(C₆H_{S}O₂)₄, Ca₃[Co₂(CN)₁₀]13H₂O, [Co(CN)₂]₂K₃Cu(CN)₄ and Co₂(SO₄)₂. Nickel catalysts comprise Ni₂(C₆H₅N₃C₆H₅), Ni₂Br₂(C₈H₆N₂) and Ni₂S₂(C₂H₂C₆H₅). Copper catalysts comprise [CuO₂CC₆H₅]₄, [CuO₂CCH₃]₄, (CuCl)₂(EtOH)₄, (CuCN)₂(EtOH)₄ and K₂Cu₄(μ₂SC₆H₅)₆.

Second and third row transition metals are organized in groups or pairs. Zirconium, hafnium, nobelium and tantalum comprise (ZrCl₂)₂, (HfCl₂)₂, (HfF₂)₂, (NbCl₂)₂, (TaCl₂)₂ and (TaF₂)₂. Molybdenum and tungsten catalysts comprise [Mo(CO)₄Cl₂]₂, [W(CO)₄Cl₂]₂, [K₄MoCl₆]₂, [Mo(CN)₂]₂K₃Cu(CN)₄, [W(CN)₂]₂K₃Cu(CN)₄, [Mo(Cl)₂]₂K₃Cu(CN)₄ and [W(Cl)₂]₂K₃Cu(CN)₄. Rhenium and technetium catalysts comprise [Re(CO)₂Cl₂(PR₃)₃]₂ and [Tc(CO)₂Cl₂(PR₃)₃]₂. Platinum, palladium, ruthenium, rhodium, osmium and iridium catalysts comprise (PtF₂)₂, (PdF₂)₂, [RuCl₂]₂(EDA)₄, [RhCl₂]₂(EDA)₄, [Ru(C₈H₆N₂)₂Cl₂]₂, [Rh(C₈H₆N₂)₂Cl₂]₂, Ru₂(O₂CR)₄Cl, Rh₂(O₂CR)₄O, [PdCl₄(PBu₃)₂]₂, [PtCl₄(PBu₃)₂]₂, [OsCl₂]₂(EDA)₄ and [IrCl₂]₂(_{EDA})₄. Silver and gold catalysts comprise (AgCN)₂K₃Cu(CN)₄ and (AuCN)₂K₃Cu(CN)₄.

A limited number of single transition metal atom catalyst complexes containing four ligands each belong to the required point group symmetry, although typically these compounds form associated molecular pairs. These catalysts comprise M(II)(C₆H_{S}O₂)₂(C₆H₆O₂)₂, M(II)(p-C₆H₅O₂)₂, M(II)(C₆H₆NO)₂(C₆H₇NO)₂ and M(II)(O₂CCH₃)₂(HO₂CCH₃)₂ plus possible solvation ligands where M represents titanium, vanadium, chromium, manganese, iron, cobalt, nickel, copper, zirconium, niobium, molybdenum, ruthenium, rhodium, palladium, silver, hafnium, tantalum, tungsten, rhenium, osmium, iridium, platinum or gold. In a limited number of complexes the transition metal atom may be mono-valent or tri-valent.

### Description of Catalyst Preparation And Chemical Conversion

Catalyst preparation may be conducted using carbon dioxide purging and/or carbon dioxide blanketing to minimize or eliminate air oxidation of the transition metal compounds during preparation. Transition metal catalysts effective for conversion of sugar materials to polyethers can be produced by combining transition metal salts in their lowest standard oxidation states with other reactants. Thus, such transition metal catalysts can be made by partially reacting transition metal (I or II) chlorides, bromides, sulfates, cyanides or similar compounds with transition metal (I or II) compounds and chelates or by forming transition metal compounds in a reduced state by similar means where di-, tri- and/or poly-metal compounds result. A number of [M(II) sulfate]₂ catalysts form by simply adding a transition metal (II) salt to an acid sulfate medium. Some alternate examples follow.

### Example 1

The (MnSO₄)₂ catalyst was prepared in a carbon dioxide atmosphere by addition of 0.284 gram (2 mmol) of sodium sulfate to 0.396 gram (2 mmol) of manganese (II) chloride tetrahydrate dissolved in 6 mL of carbon dioxide purged water with mixing and heating. A soluble colored product solution formed. The dissolved catalyst was isolated for use.

### Example 2

The (CoSO₄)₂ catalyst was prepared in a carbon dioxide atmosphere by addition of 0.536 gram (2 mmol) of sodium sulfate to 0.498 gram (2 mmol) of cobalt (II) acetate tetrahydrate dispersed in 6 mL of carbon dioxide purged water with mixing and heating. A soluble colored product solution formed. The dissolved catalyst was isolated for use.

### Example 3

The compound vanadyl sulfate (VOSO₄)₂ was prepared as described by dispersing 0.182 grams (1 mmol) of vanadium pentoxide in 1 gram of pure water, dissolving 0.264 grams (2 mmols) of ammonium sulfate and 2.3 grams (21 mmols) of concentrated (30%) hydrochloric acid. This liquid was gently purged with carbon dioxide gas to displace dissolved oxygen and 0.42 grams (6.4 mmols) of zinc dust was added in portions during a 15 minute period. The dispersion changed to a deep blue colored solution as the catalyst formed. The dissolved catalyst was used as prepared.

### Chemical Conversion To Polyethers

Sugar material conversions were conducted in a sulfate fortified dilute sulfuric acid medium by heating sugar materials with a small amount of catalyst to a temperature in the range of 75° C. to 250° C. The final temperature was maintained for a few minutes to assure completion of polymerization. Biological processes were not employed.

### Example A

Dissolved in the vial were 1.525 gram of potassium sulfate, 1.066 grams of sodium sulfate, 0.650 gram of lithium sulfate and 3 drops or 0.142 gram of vanadyl sulfate solution in 2.079 grams of water plus 3.633 grams of sulfuric acid. The mixture was purged with carbon dioxide gas prior to heating to dissolve solids. The vial was cooled and 0.884 gram of fructose was added and purged again with carbon dioxide gas. The liquid was warmed into solution and heated to 152° C. Upon cooling the polymeric solid was dispersed in water and a black polymer fluff was recovered.

### Example B

Dissolved in the vial were 2.086 gram of magnesium sulfate, 1.064 grams of sodium sulfate, 0.642 gram of lithium sulfate and 0.0156 gram of manganese sulfate and 0.027 gram of ferrous ammonium sulfate in 2.083 grams of water plus 3.604 grams of sulfuric acid. The mixture was purged with carbon dioxide gas prior to heating to dissolve solids. The vial was cooled and 0.903 gram of fructose was added and purged again with carbon dioxide gas. The liquid was warmed into solution and heated to 152° C. Upon cooling the polymeric solid was dispersed in water and a black polymer fluff was recovered.

### Example C

Dissolved in the vial were 1.526 gram of potassium sulfate, 1.071 grams of sodium sulfate, 0.643 gram of lithium sulfate and 3 drops or 0.158 gram of vanadyl sulfate solution in 2.079 grams of water plus 3.633 grams of sulfuric acid. The mixture was purged with carbon dioxide gas prior to heating to dissolve solids. The vial was cooled and 0.750 gram of fructose was added and purged again with carbon dioxide gas. The liquid was warmed into solution and heated to 180° C. Upon cooling the polymeric solid was dispersed in water and a black polymer fluff plus some clear melted polymer was recovered.

### Example D

Dissolved in the vial were 1.070 gram of potassium sulfate, 1.577 grams of sodium sulfate, 0.676 gram of lithium sulfate and 0.0156 gram of manganese chloride and 0.0164 gram of copper sulfate in 2.205 grams of water plus 3.640 grams of sulfuric acid. The mixture was purged with carbon dioxide gas prior to heating to dissolve solids. The vial was cooled and 0.899 gram of fructose was added and purged again with carbon dioxide gas. The liquid was warmed into solution and heated to 160° C. Upon cooling the polymeric solid was dispersed in water and a black polymer fluff was recovered.

### Example E

Dissolved in the vial were 2.064 gram of magnesium sulfate, 1.431 grams of sodium sulfate, 0.604 gram of lithium sulfate and 0.0176 gram of cobalt sulfate in 2.093 grams of water plus 3.616 grams of sulfuric acid. The mixture was purged with carbon dioxide gas prior to heating to dissolve solids. The vial was cooled and 0.97 gram of fructose was added and purged again with carbon dioxide gas. The liquid was warmed into solution and heated to 160° C. Upon cooling the polymeric solid was dispersed in water and a black polymer fluff was recovered.

### Example F

Dissolved in the vial were 1.560 gram of magnesium sulfate, 1.897 grams of sodium sulfate, 0.603 gram of lithium sulfate and 3 drops or 0.154 gram of vanadyl sulfate solution in 2.118 grams of water plus 3.649 grams of sulfuric acid. The mixture was purged with carbon dioxide gas prior to heating to dissolve solids. The vial was cooled and 0.977 gram of glucose was added and purged again with carbon dioxide gas. The liquid was warmed into solution and heated to 160° C. Upon cooling the polymeric solid was dispersed in water and a black polymer fluff was recovered.

### Example G

Dissolved in the vial were 1.365 gram of magnesium sulfate, 2.206 grams of sodium sulfate, 0.340 gram of lithium sulfate and 3 drops or 0.156 gram of vanadyl sulfate solution in 2.132 grams of water plus 3.658 grams of sulfuric acid. The mixture was purged with carbon dioxide gas prior to heating to dissolve solids. The vial was cooled and 0.960 gram of sucrose was added and purged again with carbon dioxide gas. The liquid was warmed into solution and heated to 160° C. Upon cooling the polymeric solid was dispersed in water and a black polymer fluff was recovered.

What is claimed:

1. Catalytic chemical conversion of sugar materials to polyethers in an acid medium.

2. Catalytic chemical conversion of sugar materials to polyethers in an acid medium containing 0.1 percent to 80 percent metal sulfates.

3. Catalytic chemical conversion of sugar materials to polyethers in an acid medium containing 0.1 percent to 80 percent metal sulfates at 75° C. to 250° C.

4. Catalytic chemical conversion of sugar materials comprising monosaccharides and disaccharides to polyethers in an acid medium containing 0.1 percent to 80 percent metal sulfates at 75° C. to 250° C.

5. Catalytic chemical conversion of sugar materials to polyethers in an acid medium containing 0.1 percent to 80 percent metal sulfates at 75° C. to 250° C. wherein catalysts possessing a degree of symmetry are formed from transition metal compounds comprising titanium, vanadium, chromium, manganese, iron, cobalt, nickel, copper, zirconium, niobium, molybdenum, ruthenium, rhodium, palladium, silver, hafnium, tantalum, tungsten, rhenium, osmium, iridium, platinum, gold or combinations thereof.

6. Catalytic chemical conversion of sugar materials comprising monosaccharides and disaccharides to polyethers in an acid medium containing 0.1 percent to 80 percent metal sulfates at 75° C. to 250° C. wherein catalysts possessing a degree of symmetry are formed from transition metal compounds comprising titanium, vanadium, chromium, manganese, iron, cobalt, nickel, copper, zirconium, niobium, molybdenum, ruthenium, rhodium, palladium, silver, hafnium, tantalum, tungsten, rhenium, osmium, iridium, platinum, gold or combinations thereof.

7. Catalytic chemical conversion of sugar materials comprising monosaccharides and disaccharides to polyethers in an acid medium containing 0.1 percent to 80 percent metal sulfates, wherein metal sulfates comprises alkali metal and alkaline earth sulfates, at 75° C. to 250° C. wherein catalysts possessing a degree of symmetry are formed from transition metal compounds comprising titanium, vanadium, chromium, manganese, iron, cobalt, nickel, copper, zirconium, niobium, molybdenum, ruthenium, rhodium, palladium, silver, hafnium, tantalum, tungsten, rhenium, osmium, iridium, platinum, gold or combinations thereof.
